(19) United States
(12) Patent Application Publication
(10) Pub. No.: US 2026/0322053 A1
(43) Pub. Date: Oct. 15, 2026

(54) BRUSH WEAR MONITORING SYSTEM OF AN ELECTRICAL MACHINE

(71) Applicant: CUTSFORTH, INC., Minneapolis, MN (US)

(72) Inventors: Robert S. Cutsforth, Bellingham, WA (US); Spencer D. Cutsforth, Bellingham, WA (US)

(73) Assignee: CUTSFORTH, INC., Minneapolis, MN (US)

(21) Appl. No.: 19/174,096

(22) Filed: Apr. 9, 2025

(51) Int. Cl. H01R 39/64

(52) U.S. Cl. CPC H01R 39/64

(57) ABSTRACT

Example brush wear monitoring systems and assemblies of an electric machine are disclosed. An example brush assembly of an electric machine includes a carbon brush including an upper surface, a lower surface opposite the upper surface, and a longitudinal channel extending into the brush from the upper surface. The longitudinal channel includes a lower region having a first width and an upper region having a second width at the upper surface that is greater than the first width. The system may also include a spacer having a keel configured to be inserted into the longitudinal channel. The keel includes a base portion having tapering sidewalls extending downward from the body and a blade having first and second parallel sidewalls extending downward from the base portion.

### TECHNICAL FIELD

The disclosure generally relates to monitoring systems for monitoring brushes and brush holder assemblies that may be used in electrical devices and/or slip ring assemblies. More specifically, the disclosure relates to monitoring apparatus, assemblies, systems and methods of monitoring the wear of a brush in a brush holder assembly and/or the condition of a slip ring of an electrical device using a sensor.

### BACKGROUND

A purpose of a brush in an electrical device is to pass electrical current from a stationary contact to a moving contact surface, or vice versa. Brushes and brush holders may be used in electrical devices such as electrical generators, electrical motors, and/or slip ring assemblies, or sliding connection applications, for example, slip ring assemblies on a rotating machine such as a rotating crane or a linear sliding connection on a monorail. Brushes in many electrical devices are blocks or other structures made of conductive material, such as graphite, carbon graphite, electrographite, metal graphite, or the like, that are adapted for contact with a conductive surface or surfaces to pass electrical current. Electrically conductive leads or shunts extend from the brush to provide an electrical pathway to and/or from the brush from another conductive member.

In some designs, a brush box type brush holder, or other type of brush holder, may be used to support a brush in contact with a moving contact surface of an electrical device during operation. The brush and brush box may be designed such that the brush can slide within the brush box to provide for continuing contact between the brush and the moving contact surface contacted by the brush. During operation an anomalous and/or threshold condition may occur, which may be indicative that one or more components of the electrical device may need to be replaced, one or more components of the electrical device may require inspection or attention, and/or maintenance may need to be performed. For example, an anomalous and/or threshold condition may indicate that one or more of a brush, brush holder, spring, shunt, commutator, collector ring, and/or other component may need to be replaced, one or more of a brush, brush holder, spring, shunt, commutator, collector ring, and/or other component may need to be inspected, and/or maintenance may need to be performed. It would be advantageous to monitor one or more components of an electrical device in order to observe the occurrence of an anomalous and/or threshold condition. Furthermore, it would be advantageous to alert an operator and/or technician of the occurrence of an anomalous and/or threshold condition and/or schedule technician intervention.

### SUMMARY

The disclosure is directed to monitoring apparatus, assemblies, systems and methods of monitoring the wear of a brush in a brush holder assembly and/or the condition of a slip ring of an electrical device using a sensor.

A first example is a carbon brush assembly for an electrical device. The assembly includes a carbon brush including an upper surface, a lower surface opposite the upper surface, a front surface extending from the upper surface to the lower surface, and a rear surface opposite the front surface, the rear surface extending from the upper surface to the lower surface. The assembly also includes one or more lead wires extending out of the carbon brush at an insertion point on the upper surface. A longitudinal channel extends into the carbon brush from the upper surface at a location spaced away from the insertion point of the one or more lead wires and unobstructed by the one or more lead wires. The longitudinal channel includes a lower region having a first width and an upper region having a second width at the upper surface. The second width is greater than the first width.

Alternatively or additionally to any of the examples herein, in another example, the lower region of the longitudinal channel is defined between first and second opposing sidewalls.

Alternatively or additionally to any of the examples herein, in another example, the first and second opposing sidewalls are parallel.

Alternatively or additionally to any of the examples herein, in another example, the lower region further includes a concave base wall extending from the first sidewall to the second sidewall.

Alternatively or additionally to any of the examples herein, in another example, the upper region is defined by tapering sidewalls tapering outwardly from the lower region toward the upper surface.

Alternatively or additionally to any of the examples herein, in another example, the longitudinal channel extends from the front surface to the rear surface.

Alternatively or additionally to any of the examples herein, in another example, an upper extent of the longitudinal channel at the upper surface of the brush is the widest portion of the longitudinal channel.

Another example is a system for monitoring the wear state of a carbon brush. The system includes a carbon brush including an upper surface and a lower surface opposite the upper surface, a front surface extending from the upper surface to the lower surface, and a rear surface opposite the front surface. The rear surface extends from the upper surface to the lower surface. The carbon brush including a longitudinal channel extending into the carbon brush from the upper surface. The longitudinal channel extends from the front surface to the rear surface. The system also includes a spacer including a body and a keel extending from a lower surface of the body. The lower surface of the body is juxtaposed with the upper surface of the carbon brush such that the keel extends into the longitudinal channel of the carbon brush from the upper surface. The system also includes a wear state monitor positioned within a cavity of the body of the spacer. The keel includes a base portion extending downward from the body and a blade extending downward from the base portion. The blade includes first and second parallel sidewalls.

Alternatively or additionally to any of the examples herein, in another example, the longitudinal channel includes a lower region having a first width and an upper region having a second width at the upper surface of the carbon brush, wherein the second width is greater than the first width.

Alternatively or additionally to any of the examples herein, in another example, wherein the base region of the keel is positioned in the upper region of the longitudinal channel and the blade of the keel is positioned in the lower region of the longitudinal channel.

Alternatively or additionally to any of the examples herein, in another example, the lower region of the longitudinal channel includes first and second opposing sidewalls.

Alternatively or additionally to any of the examples herein, in another example, the first and second opposing sidewalls of the lower region of the longitudinal channel are parallel.

Alternatively or additionally to any of the examples herein, in another example, the first and second parallel sidewalls of the blade frictionally engage the first and second opposing sidewalls of the lower region of the longitudinal channel.

Alternatively or additionally to any of the examples herein, in another example, the base portion of the keel includes first and second tapered walls.

Alternatively or additionally to any of the examples herein, in another example, the longitudinal channel includes an upper region having first and second tapering sidewalls and a lower region having first and second parallel sidewalls.

Alternatively or additionally to any of the examples herein, in another example, the first and second tapered walls of the keel are facing the first and second tapering sidewalls of the upper region of the longitudinal channel.

Alternatively or additionally to any of the examples herein, in another example, the first and second tapered walls of the keel are spaced away from the first and second tapering sidewalls of the upper region of the longitudinal channel when the keel is positioned in the lower region of the longitudinal channel.

Alternatively or additionally to any of the examples herein, in another example, the blade is frictionally engaged with the first and second parallel sidewalls of the lower region of the longitudinal channel.

Another example is a brush wear monitoring assembly. The assembly incudes a spacer and a wear state monitor. The spacer includes a body, a keel extending from a lower surface of the body, first and second arms extending from the body and spaced apart from one another, a first pin extending from an inner surface of the first arm toward the second arm, and a second pin extending from an inner surface of the second arm toward the first arm. The first pin is coaxial with the second pin. The wear state monitor is positioned within a cavity of the body of the spacer.

Alternatively or additionally to any of the examples herein, in another example, the keel includes a base portion having tapering sidewalls extending downward from the body and a blade extending downward from the base portion, the blade including first and second parallel sidewalls.

The above summary of some embodiments, aspects, and/or examples is not intended to describe each embodiment or every implementation of the present disclosure. The figures and the detailed description which follows more particularly exemplify these embodiments.

### BRIEF DESCRIPTION OF THE DRAWINGS

The aspects of the disclosure may be more completely understood in consideration of the following detailed description of various embodiments in connection with the accompanying drawings, in which:

FIG. 1 shows an illustrative perspective view of an exemplary brush monitoring system;

FIG. 2 shows an example brush assembly for installation in a brush holder assembly of the brush monitoring system of FIG. 1;

FIG. 3 is a side view of the brush assembly of FIG. 2;

FIG. 3A is an enlarged view of a portion of the brush assembly of FIG. 3;

FIG. 4 is a top view of the brush assembly of FIG. 2;

FIG. 5 is a perspective view of components of a brush holder assembly of the brush monitoring system of FIG. 1;

FIG. 6 is a perspective view of components of the brush holder assembly of FIG. 5 when disconnect from one another;

FIG. 7 is a side view of the components of FIG. 6 when connected together;

FIG. 8 illustrates components of a wear state monitory assembly of the brush monitoring system of FIG. 1 including a wear state monitor decoupled from a spacer;

FIG. 9 is a side view of the spacer of FIG. 8;

FIG. 10 is a top view of the spacer of FIG. 8;

FIG. 11 is a front view of the spacer of FIG. 8;

FIG. 12 is a side view of the brush monitoring system of FIG. 1 with the wear state monitor assembly in a first, disengaged position;

FIG. 13 is a side view of the brush monitoring system of FIG. 1 with the wear state monitor assembly in a second, engaged position;

FIG. 14 is a front view of the brush monitoring system of FIG. 1 with the wear state monitor assembly in the second, engaged position of FIG. 13; and

FIG. 14A is an enlarged view of a portion of the brush monitoring system of FIG. 14.

While the aspects of the disclosure are amenable to various modifications and alternative forms, specifics thereof have been shown by way of example in the drawings and will be described in detail. It should be understood, however, that the intention is not to limit aspects of the disclosure to the particular embodiments described. On the contrary, the intention is to cover all modifications, equivalents, and alternatives falling within the spirit and scope of the disclosure.

### DETAILED DESCRIPTION

For the following defined terms, these definitions shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (i.e., having the same function or result). In many instances, the term “about” may be indicative as including numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

Although some suitable dimensions, ranges and/or values pertaining to various components, features and/or specifications are disclosed, one of skill in the art, incited by the present disclosure, would understand desired dimensions, ranges and/or values may deviate from those expressly disclosed.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following detailed description should be read with reference to the drawings in which similar elements in different drawings are numbered the same. The detailed description and the drawings, which are not necessarily to scale, depict illustrative embodiments and are not intended to limit the scope of the disclosure. The illustrative embodiments depicted are intended only as exemplary. Selected features of any illustrative embodiment may be incorporated into an additional embodiment unless clearly stated to the contrary.

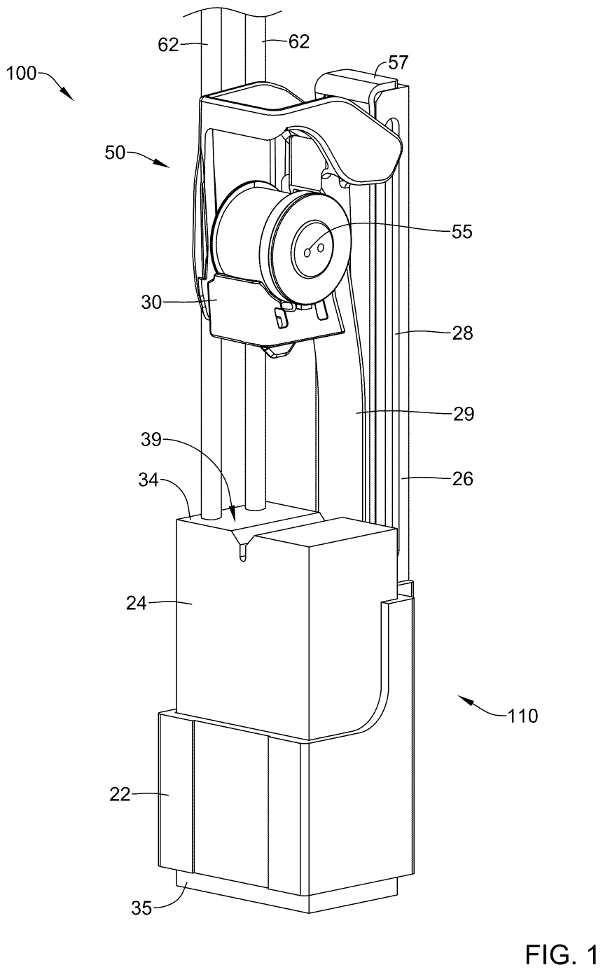

FIG. 1 illustrates an exemplary brush monitoring system 100 that may include a brush holder assembly 110. It is noted that the brush monitoring system 100 include other components, such as a site monitor and/or a remote monitoring site, as disclosed in U.S. Pat. No. 11,211,757, entitled “SYSTEM AND METHOD FOR MONITORING THE STATUS OF ONE OR MORE COMPONENTS OF AN ELECTRICAL MACHINE” and U.S. Pat. No. 11,355,991, entitled ““SYSTEM AND METHOD FOR MONITORING THE STATUS OF ONE OR MORE COMPONENTS OF AN ELECTRICAL MACHINE”, which are both herein incorporated by reference in their entirety.

The illustrative brush monitoring system 100 may be amenable to any of various brush holder assembly configurations. Thus, the intention is that the illustrative brush monitoring system 100 may be used in conjunction with any desired brush holder assembly configurations of an electrical device, such as an industrial electrical generator. For example, the illustrative brush monitoring system 100 may be used with brush holder assemblies, brush holders and/or brushes disclosed in U.S. Pat. Nos. 7,034,430; 6,731,042; 5,753,992; 5,621,262; 5,463,264; 5,397,952; and 5,256,925; each of which is incorporated herein by reference.

The brush holder assembly 110 may include a brush 24 (e.g. a carbon brush) slidably received in a brush holder 22. The brush 24 includes a first end surface 34 and a second end surface 35 and a length extending therebetween. The second end surface 35 may be in electrical contact with a conductive surface of a rotating component of an electrical machine (e.g., a collector ring, a slip ring, or a commutator) and conduct electrical current therefrom. Further, FIG. 1 illustrates that, in some examples, one or more sides of the brush 24 may be surrounded by the brush holder 22 (e.g., a brush box), whereby the brush holder 22 may include a plurality of guiding surfaces for guiding linear or longitudinal movement of the brush 24 along a longitudinal axis of the brush 24 toward the conductive surface of the rotating component of the electrical machine. In other words, the brush 24 may translate linearly within an aperture defined by the plurality of guiding surfaces of the brush holder 22 as the brush 24 wears. In some embodiments it is contemplated that the brush holder 22 may not take on the form of a box, but may include one or a plurality of guiding surfaces, such as channels, posts or columns, abutting and/or encompassing one or more sides of the brush 24 and/or extending into or through the brush 24, or a portion thereof, for guiding linear or longitudinal movement of the brush 24.

FIG. 1 further illustrates that the brush holder 22 may be secured to a mounting beam 26 configured and adapted to be mounted to another structure. The brush holder assembly 110 may be configured to place the brush 24 in contact with a conductive surface, such as the surface of a rotating component of the electrical machine. The brush 24 may extend from the lower edge of the brush holder 22 such that the second end surface 35 of the brush 24 engages the conductive surface of the electrical machine.

The mounting beam 26 may include opposing side surfaces, having a longitudinal channel 28 extending therealong (only 1 channel 28 is visible in FIG. 1). In other words, the mounting beam 26 may include a first longitudinal channel 28 extending along a first side surface of the mounting beam 26 an da second longitudinal channel 28 extending along an opposite, second side surface of the mounting beam 26. The longitudinal axis of the longitudinal channels 28 may be parallel to the longitudinal axis of the mounting beam 26.

FIG. 1 further illustrates that the brush holder assembly 110 may include a wear state monitor 50 and a spacer 30. FIG. 1 illustrates the wear state monitor 50 and the spacer 30 spaced away from the brush. However, in use, the spacer 30 may be engaged with the first end surface 34 of the brush 24. Additionally, FIG. 1 illustrates that the wear state monitor 50 may be coupled to a spring 29. In some examples, a portion of the spring 29 may be coiled around a portion of the wear state monitor 50, with an elongate portion of the spring 29 extending from the coiled portion along a side surface of the brush 24.

In some examples, the wear state monitor 50 may be mounted adjacent a surface of the spring 29 or otherwise within the spring 29, such as within a coiled portion of the spring 29. The spring 29 may include a constant force spring, which provides tension to the brush 24, the wear state monitor 50 or both the brush 24 and the wear state monitor 50 to bias the brush 24 toward and in contact with the conductive surface of the rotating component of the electrical machine. In other words, the spring 29 may include a coiled portion designed to provide a force to engage the brush 24 with a rotating component of an electrical machine, such as a slip ring, a commutator, and the like.

In some examples, the spring 29 may be attached to a portion of the brush holder 22 and/or the mounting beam 26 of the brush holder assembly 110. In some instances, a first end 32 of the spring 29 may be removably coupled to the brush holder and/or the mounting beam 26 with an elongate portion of the spring 29 extending along a side surface of the brush 24, between the brush 24 and the mounting beam 26. Thus, in some embodiments, an elongate portion of the spring 29 may extend along one side surface of the brush 24 between the brush 24 and the mounting beam 26 of the brush holder assembly 110 up to the coiled portion of the spring 29 positioned above the upper surface 34 of the brush 24. The opposite, second end of the spring 29 may be located at the interior of the coiled portion of the spring 29. Further detailed discussion of the wear state monitor 50, the spacer 30 and the spring 29 follows below.

In some examples the wear state monitor 50 may include one or more sensors which collect and/or measure a variety of parameters corresponding to the “wear state” of the brush 24. For example, the wear state monitor 50 may include one or more sensors which measure and/or communicate the extent to which the brush 24 wears away while in contact with the conductive surface of the rotating component of the electrical machine. In some examples, the sensor(s) may also measure the vibration and/or temperature of the brush holder assembly 110 (including individual components thereof) and/or the brush 24, and/or electrical current passing through the brush 24, for instance.

In some cases, the wear state monitor 50 may also include one or more indicators 55 (e.g., one or more light emitting diodes (LEDs), a speaker, or a combination of LEDs and/or speakers) for communicating wear state information to a user. In some instances, the wear state monitor 50 may be capable of communicating information about the wear state of the brush 24 and/or the rotating component of the electrical machine to a user via the indicators 55. In some cases, the wear state monitor 50 may be capable of receiving messages from an external device, such as a site monitor and/or a programming device located at the same site or at a remote location (e.g., a computer, a tablet, a smart phone, etc.). The messages may include commands, such as commands to send wear state information about the brush 24 and/or the rotating component, or commands for modifying information used by the wear state monitor 50. For example, a user may desire to modify one or more thresholds used to determine the wear state information of the brush 24 and/or the rotating component of the electrical machine, and/or to reprogram the wear state monitor 50 by downloading instructions, tables and/or the like.

As described above, in some examples the wear state monitor 50 may measure and/or collect information regarding the wear state of the brush 24. In particular, the wear state monitor 50 may be designed to measure and collect information regarding the extent to which the second end surface 35 of the brush 24 contacting the conductive surface has worn away (i.e., the amount of diminution in length of the brush 24 at some time from its initial length when installed in the brush holder assembly 110). It can be appreciated that as the second end surface 35 of the brush 24 maintains contact with the rotating component, the second end surface 35 of the brush 24 may wear away, thereby shortening the overall length of the brush 24.

The wear state monitor 50, or associated site monitor, may output an indication of the condition and/or projected condition of the brush 24. In some cases, the indication may be configured to alert an operator, technician and/or other personnel that the brush 24 and/or the rotating component of the electrical machine are sufficiently worn and/or needs to be replaced, the brush 24 and/or the rotating component of the electrical machine are damaged, failure has occurred or is imminent, or other maintenance or inspection may need to be performed. In some embodiments, the indication may be used for scheduling maintenance or inspection, sending personnel to perform maintenance or inspection, ordering and/or scheduling distribution/delivery of a replacement brush or other part, routing maintenance personnel and/or product delivery to a specified location, or arranging for other notification and/or scheduling tasks be performed.

The brush monitoring system 100 may also be used to identify and/or notify other key maintenance, failure of the brush holder assembly 110 and/or other anomalous conditions. For example, incidents of excess heating, arcing or excess vibration, which may indicate a need to perform maintenance and/or disrupt operation of the electrical equipment, may be identified and/or assessed by one or more components of the brush monitoring system 100. The wear state monitor 50, an associated site monitor, and/or a remote monitoring device may carry out an appropriate response to respond to an identified anomalous condition in an attempt to rectify the anomalous condition. In some cases, an operator may carry out an appropriate response to respond to an anomalous condition identified with the brush monitoring system 100 in an attempt to rectify the anomalous condition.

In some cases, one or more parameters received from the wear state monitor 50 associated with a brush holder assembly 110 may be monitored over time to determine trending information about a brush 24 and/or a rotating component 15 of the electrical machine. For example, a site monitor and/or a remote monitoring device may determine trend information, that may include an average lifetime for a brush 24 installed in a particular brush holder assembly 110 and/or for a particular installation position on an electrical machine. The site monitor and/or the remote monitoring device may be configured to store information about the position of a brush 24 when the brush 24 and/or brush holder assembly 110 is first installed on an electrical machine. By monitoring the final position and/or replacement date of a brush 24 along with the initial position and/or installation date each time a brush 24 is replaced and a new brush 24 is installed in the brush holder assembly 110, information may be gathered about a wear state of the rotating component of the electrical machine. For example, a slip ring, or other rotating component of the electrical machine, may have an initial outer diameter measurement. Over time, with wear including normal wear and/or due to environmental conditions (e.g., humidity, temperature, contaminants including abrasives, etc.) a wear state associated with the thickness and/or outer diameter of the rotating component may be measured and/or predicted. In some cases, preventative measures to improve the lifetime of the brush 24 and/or the rotating component may be obtained by analysis of the information received from the one or more wear state monitors 50. For example, a user may be advised to adjust one or more environmental conditions for a space near the electrical machine, such as a temperature, a humidity level and/or a contaminant level.

As described above, the spring 29 may apply a force to the brush 24 which is directed linearly along the aperture defined by the brush holder 22 that the brush 24 is slidably disposed within. Further, as the brush 24 decreases in length within the brush holder 22, the wear state monitor 50 may rotate within the coiled portion of the spring 29 while the axis of rotation of the wear state monitor 50 translates linearly with linear translation of the brush 24 toward the conductive surface 12 of the rotating component 15. Thus, the wear state monitor 50 may move with the brush 24 as the brush 24 diminishes in length.

In some examples the wear state monitor 50 and the coiled portion of the spring 29 may be nested within the spacer 30, such as within a concave cradle of the spacer 30. The spacer 30 may be positioned between the coiled portion of the spring 29 and the upper or first end surface 34 of the carbon brush 24. In some instances, the spacer 30 may be engaged with, in contact with, and/or attached to the first end surface 34 of the brush 24 such that the spacer 30, as well as the wear state monitor 50 coupled therewith, moves with the brush 24.

Additionally, a sensor, which may be positioned within the wear state monitor 50 or within the spacer 30 adjacent to the wear state monitor 50, may measure and collect data representing the extent (e.g., total angular distance and/or total arc length) of rotation of the wear state monitor 50 from its initial position when the brush 24 was installed in the brush holder assembly 110, or any other duration desired. It can be appreciated that the amount of rotation measured by the sensor may be equivalent, proportional, or otherwise representative of the linear or longitudinal movement of the brush 24 as it translates (e.g., shortens) within the brush holder 22, and thus equivalent, proportional, or otherwise representative of the amount of diminution of the brush 24 from its initial length. The amount of rotation of the wear state monitor 50 may also be equivalent to the mount of rotation of the coiled portion of the spring 29 surrounding the wear state monitor 50. Thus, the sensor may measure and collect data representing the extent (e.g., total angular distance and/or total arc length) of rotation of the coiled portion of the spring 29 from its initial position when the brush 24 was installed in the brush holder assembly 110, or any other duration desired.

In some cases, the sensor may associate the rotation of the wear state monitor 50 with a wear state of the brush 24 and/or a wear state of the conductive surface and/or the rotating component of the electrical machine. The value (e.g., amount of rotation of the wear state monitor 50) measured by the sensor may correspond to the position of the first end surface 34 of the brush 24 relative to the lower edge of the brush holder 22, and thus relative to the conductive surface of the rotating component of the electrical machine. In some cases, the value measured by the sensor may correspond to a value obtained over any desired time interval or duration of wear of the brush 24. It can be appreciated that the value (e.g., amount of rotation of the wear state monitor 50 from its initial position) may be compared to one or more predetermined threshold values to determine a wear state of the brush 24 and/or other diagnostic information about the machine.

The sensor may be positioned within the wear state monitor 50 or within the spacer 30 adjacent to the wear state monitor 50, and may measure and collect data representing a current rotational position of the wear state monitor 50 which can be used to determine the extent (e.g., total angular distance and/or total arc length) of rotation of the wear state monitor 50 from its initial position whereby the amount of rotation of the wear state monitor 50 measured by the sensor may be equivalent, proportional, or otherwise representative of the linear or longitudinal movement of the brush 24 as it translates (e.g., shortens) within the brush holder 22. In particular, the sensor may be designed to detect the absolute angular position of the sensor relative to a permanent magnet positioned adjacent the sensor. In instances in which the sensor is positioned within the wear state monitor 50 the magnet may be attached to the spacer 30, or otherwise incorporated with the spacer 30. In instances in which the sensor is provided with the spacer 30, the magnet may be attached to or disposed within the wear state monitor 50, or otherwise incorporated with the wear state monitor 50. In some instances, the sensor may be referred to as an angular sensor and/or a magnetic encoder.

The wear state monitor 50 and/or the spacer 30 may further include a power source (e.g., one or more batteries, capacitors, or both) to power the sensor and/or power a communication module transmitting data from the sensor to a site monitor or other data collection system. The power source may be rechargeable and/or replaceable.

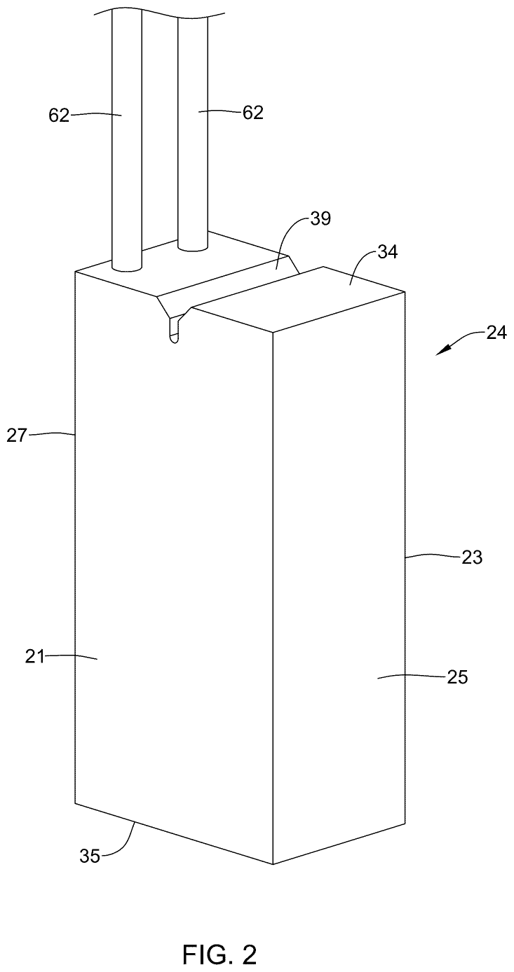

FIGS. 2-4 illustrate aspects of the brush 24 of the brush holder assembly 110. The brush 24 may be a generally rectangular solid, including a plurality of side surfaces extending between the first, upper surface 34 and the second, lower surface 35 of the brush 24. For example, the brush 24 may include a first, front surface 21 and an opposing second, rear surface 23 extending along opposite sides of the brush 24 between the upper surface 34 and the lower surface 35. The brush 24 may also include a third, side surface 25 and an opposing fourth, side surface 27 extending along opposite sides of the brush 24 between the upper surface and the lower surface 35.

The brush 24 may include a longitudinal channel 39 extending into the brush 24 from the upper surface 34 of the brush 24. The longitudinal channel 39 may extend across an entire width of the brush 24 from the front surface 21 to the rear surface 23, such that the longitudinal channel 39 opens out to each of the upper surface 34, the front surface 21, and the rear surface 23. In other instances, the longitudinal channel 39 may extend along only a portion for the width of the brush 24, such that the longitudinal channel 39 does not extend to the front surface 21 and/or the rear surface 23. In such instances, the longitudinal channel 39 may open out to the upper surface 34, but not open out to at least one of the front surface 21 or the rear surface 23.

The brush 24 may include one or more electrically conductive lead wires 62 extending from the upper surface 34. The longitudinal channel 39 may be spaced away from the one or more of the lead wires 62 extending from the upper surface 34. For example, each of the lead wires 62 may extend into the brush 24 from the upper surface 34 of the carbon brush 24 at an insertion point along the first end surface 34 of the brush 24. For instance, the ends of the lead wires 62 may be fixed within bore holes of the brush 24. As shown in FIGS. 2-4, the longitudinal channel 39 may be spaced away (along the upper surface 34 of the brush 24) from the insertion locations of the lead wires 62. Thus, the longitudinal channel 39 is distinct from and not intended for receiving ends of the lead wires 62 therein.

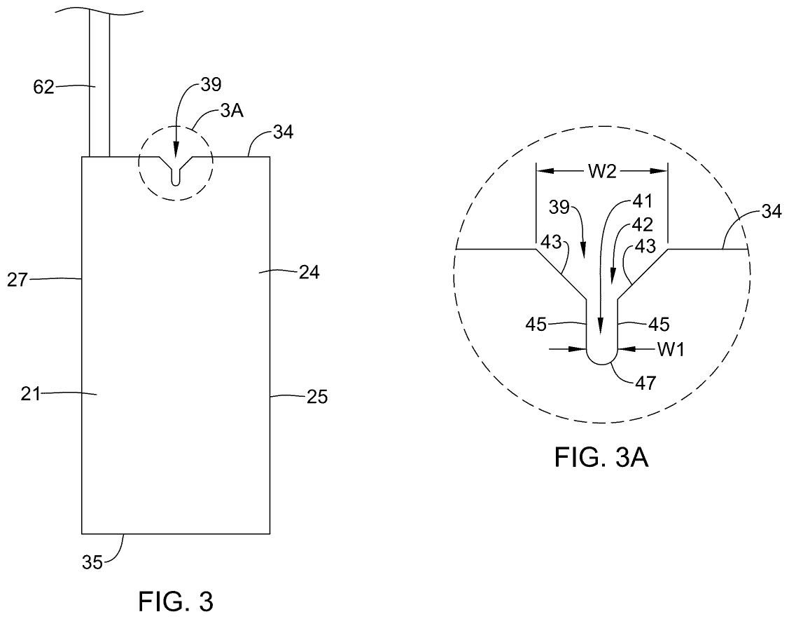

As shown in FIG. 3, the longitudinal channel 39 may be centered laterally between the third side surface 25 and the fourth side surface 27, such that the longitudinal channel 39 is equidistantly spaced away from each of the third side surface 25 and the fourth side surface 27. In other instances, the longitudinal channel 39 may be positioned closer to one of the side surfaces 25, 27 than the other one of the side surfaces 25, 27.

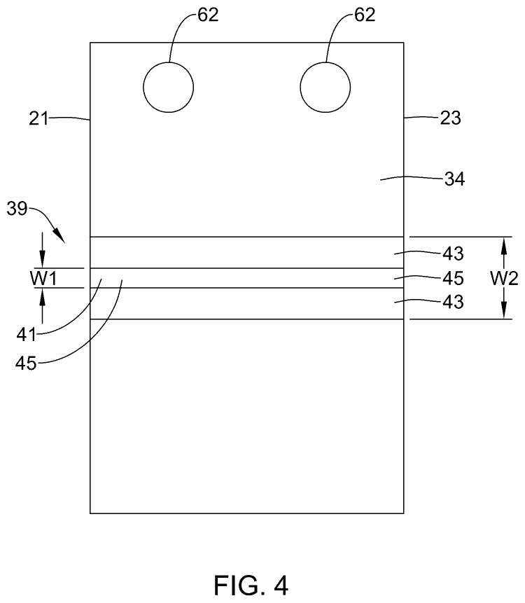

Turning to FIG. 3A, which is an enlarged view of a portion of FIG. 3, further details of the longitudinal channel 39 will be noted. The longitudinal channel 39 may be a compound shape having a lower region 41 extending to a base 47 of the longitudinal channel 39, and an upper region 42 extending to the upper surface 34 of the brush 24. The lower region 41 may be considered as a slot extending from the front surface 21 to the rear surface 23. The lower region 41 may be defined between two side walls 45, such as two parallel side walls 45, while the upper region 42 may be defined between two converging or angled side walls 43. The angled side walls 43 of the upper region 42 may extend into the brush 24 from the upper surface 34 at an acute angle to the upper surface 34. In some instances, the two side walls 45 may be non-parallel such that the two side walls 45 extend at an angle to the upper surface 34 different from the angled side walls 43. The lower region 41 may have a first width W1 measured between the opposing side walls 45, whereas the upper region 42 may widen from the first width W1 to a second width W2 at the upper surface 34 of the brush 24. The second width W2 may be greater than the first width W1 providing a tapering profile for the upper region 42 of the longitudinal channel 39. Thus, the upper extent of the longitudinal channel 39 at the upper surface 34 of the brush 24 is the widest portion of the longitudinal channel 39. The top view shown in FIG. 4 further illustrates the configuration of the longitudinal channel 39, with the angled side walls 43 of the upper region 42 converging to the parallel side walls 45 of the lower region 41. The side walls 45 of the lower region 41 may be non-planar, and thus non-parallel to the angled side walls 43 of the upper region 42. In other words, a first one of the side walls 45 of the lower region 41 may converge with a first one of the angled side walls 43 of the upper region 42 at an oblique angle, and a second one of the side walls 45 of the lower region 41 may converge with a second one of the angled side walls 43 of the upper region 42 at an oblique angle. The lower region 41 extends from the upper region 42 toward the lower surface 35 of the brush 24. In some instances, the base 47 of the lower region 41 may include a concave surface extending between the parallel side walls 45.

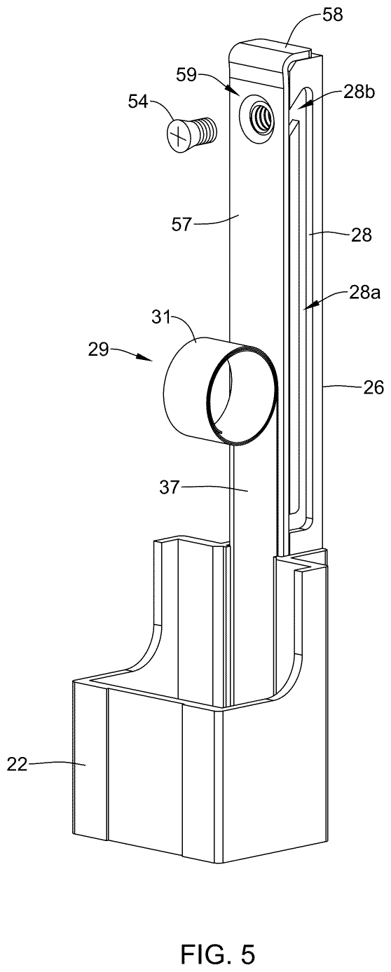

Aspects of the spring 29 in association with the brush holder 22 and the mounting beam 26 are shown in FIGS. 5-7. The spring 29 may be coupled to and extend along a back plate 57. The back plate 57, in turn, may extend along and be secured to the mounting beam 26, such that the back plate 57 extends between the spring 29 and the mounting beam 26. For example, the back plate 57 may include an aperture 59 through which a threaded fastener 54 may be positioned to threadably engage a threaded bore of the mounting beam 26 to removably secure the back plate 57 to the mounting beam 26. Other securement mechanisms are also contemplated. The back plate 57 may include a lip 58 located at the upper end of the back plate 57 configured to be positioned against an upper surface of the mounting beam 26 when secured thereto. The aperture 59 of the back plate 57 may be axially aligned with the threaded bore of the mounting beam 24 when the lip 58 is positioned against the upper surface of the mounting beam 26. The spring 29, which incudes a coiled portion 31 and an elongated portion 37 extending from the coiled portion 31, may be positioned between the back plate 57 and a brush 24 (not shown in FIG. 5) positioned within the brush holder 22. The elongated portion 37 may extend from the coiled portion 31 to the first end 32 of the spring 29. The second end 33 of the spring 29 may be positioned at the inner extent of the coiled portion 31.

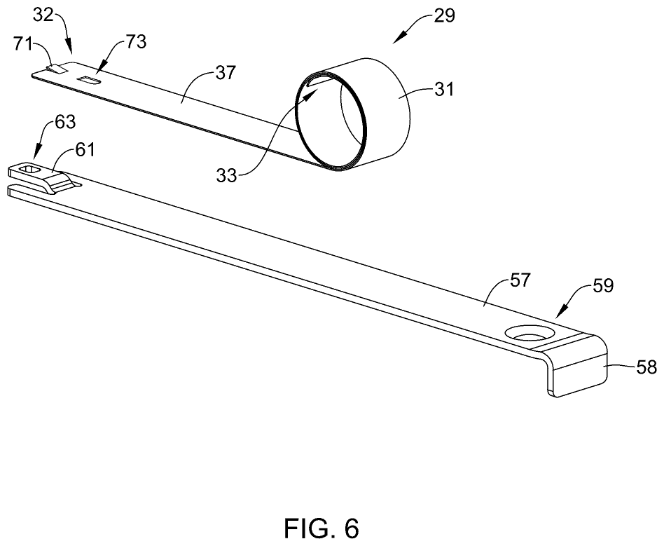

The spring 29 may be releasably attached to the back plate 57 without using fasteners such that the spring 29 may be readily removed and replaced as needed. For instance, as shown in FIG. 6, the lower end of the back plate 57 (i.e., the end of the back plate opposite the lip 58) may include a tab 61 extending out of the plane of the back plate 57, defining a gap between the tab 61 and the base of the back plate 57. The tab 61 may include an opening 63 extending into and/or through the tab 61. The first end 32 of the spring 29 may include a tab 71 extending out of the plane of the remainder of the first end 32 of the spring 29, and an opening 73 extending through the spring 29.

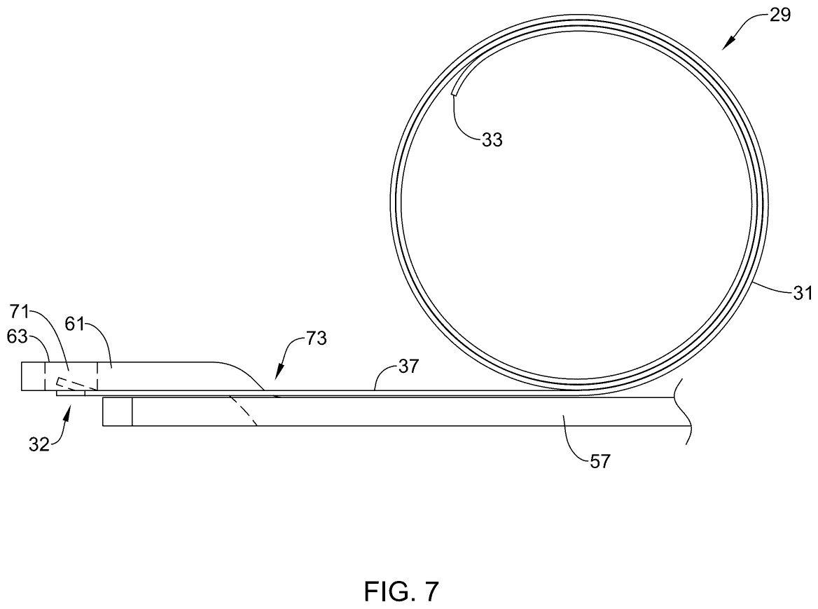

Referring to FIG. 7, the first end 32 of the spring 29 may be releasably attached to the back plate 57 by extending the tab 61 of the back plate 57 through the opening 73 of the spring 29 such that the first end 32 of the spring 29 is positioned in the gap between the tab 61 and the base of the back plate 57. The tab 71 of the spring 29 may also extend into the opening 63 formed in the tab 61 of the back plate 57. Thus, the spring 29 may be coupled to the back plate 57 without tools and/or fasteners, and may be readily removed or decoupled from the back plate 57 without tools.

The back plate 57, with the spring 29 attached thereto, may be secured to the mounting beam 26 of the brush holder 22 as described above. As shown in FIG. 5, the mounting beam 26 may include an elongate channel 28 extending along opposing side surfaces of the mounting beam 26 (only elongate channel 28 is shown in FIG. 5, however, it is understood that the opposing side of the mounting beam 26 would include a similar elongate channel 28). The elongate channel 28 includes an elongate portion 28a extending parallel to the longitudinal axis of the mounting beam 26, and a lateral portion 28b extending away from the elongate portion 28a. For instance, the lateral portion 28b may extend from the elongate portion 28a at an oblique angle to the longitudinal axis of the mounting beam 26. The lateral portion 28b may extend to and open out to the front face of the mounting beam 26, against which the back plate 57 may be mounted to. The back plate 57 may extend across an open end of the lateral portion 28 at the front face of the mounting beam 26. Further aspects of the elongate channels 28 in association with the engagement of the spacer 30 therein will be described later herein.

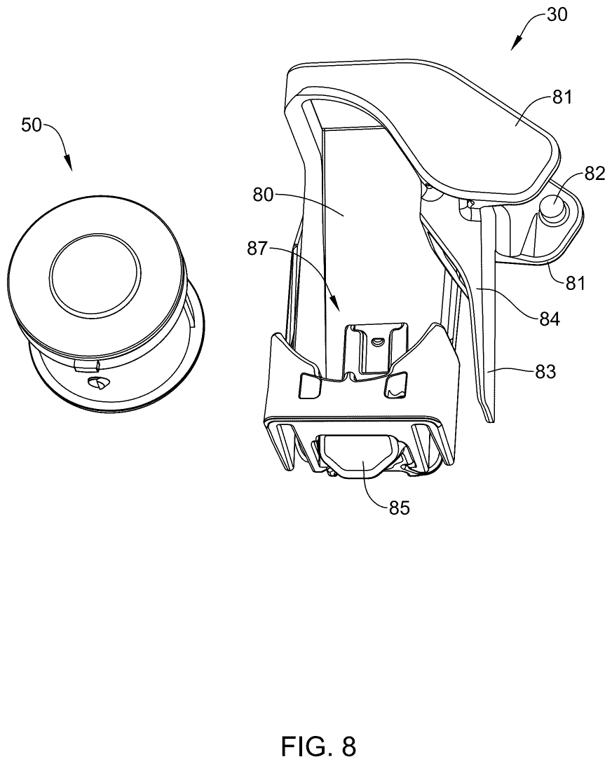

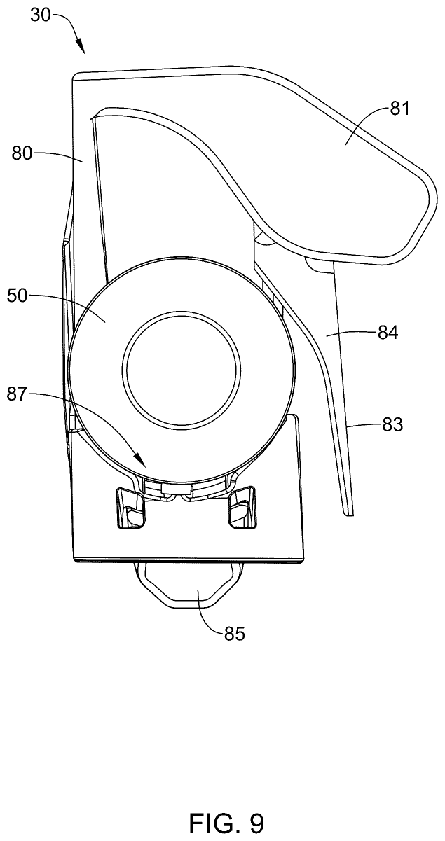

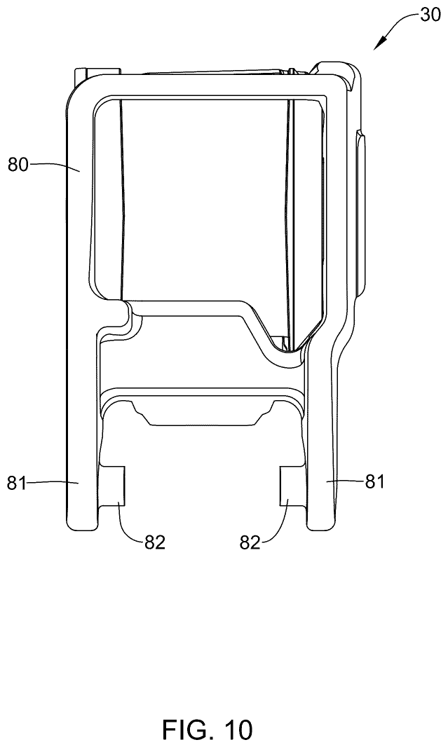

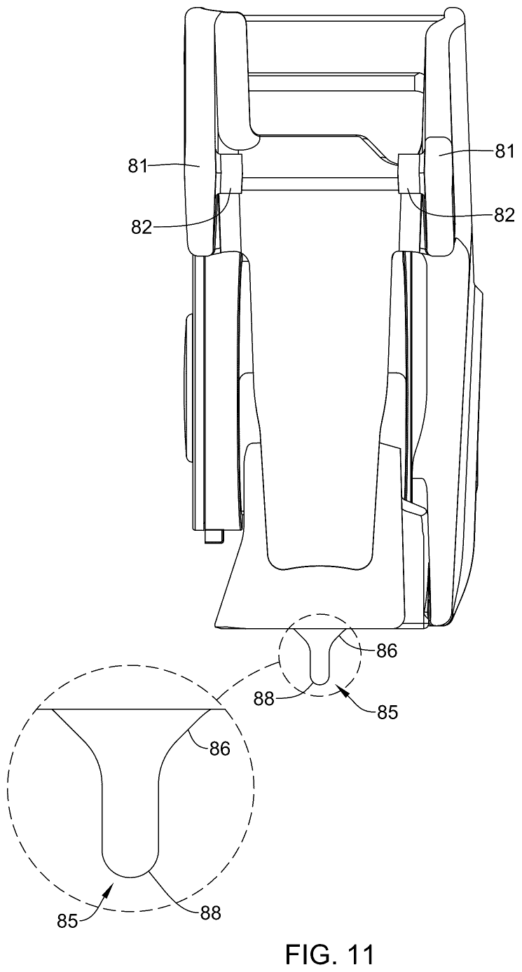

Further aspects of the wear state monitor 50 and the spacer 30 are illustrated in FIGS. 8-11. The spacer 30 may include a body 80 defining a cavity 87 configured to receive the wear state monitor 50 therein. The spacer 30 may also include first and second arms 81 extending from the body 80. In some instances, the first and second arms 81 may extend generally parallel, substantially parallel, or parallel to one another. A first pin 82 may extend from the first arm 81 toward the second arm 81, and likewise, a second pin 82 may extend from the second arm 81 toward the first arm 81. In some instances, the first pin 82 may extend from an inner surface of the first arm 81, facing the second arm 81, toward the second arm 81. Likewise, in some instances, the second pin 82 may extend from an inner surface of the second arm 81, facing the first arm 81, toward the first arm 81. The first pin 82 may be coaxial with the second pin 82, such that the first and second pins 82 extend along the same axis.

The spacer 30 may also include a tongue 84 extending from the body 80. The tongue 84 may help support the spacer 30 within the brush holder assembly 110, such as against the back plate 57. The tongue 84 may be an elongated member extending downward between the first and second arms 81. The tongue 84 may include a rear surface 83 facing the back plate 57. The rear surface 83 may be a flat surface in some instances. The rear surface 83 may be juxtaposed with and in contact with the front surface of the back plate 57 when positioned in an engaged portion, as described further herein.

The spacer 30 may also include a keel 85 extending downward from a lower extent of the body 80. The keel 85 may have a desired shape to be insertable into the longitudinal channel 39 of the brush 24. The keel 85 may have a base region 86 and a blade 88 extending downward from the blade 88. The base region 86 may have a width greater than a width of the blade 88. For example, the blade 88 may have a generally uniform width measured between two opposing, parallel sidewalls of the blade 88 while the base region 86 may have tapered sidewalls tapering outwardly from the sidewalls of the blade 88 in an upward direction to the body 80 of the spacer 30. It is noted that the opposing sidewalls of the blade 88 need not be parallel, if desired. The tip of the blade 88 may have a convex surface extending between the opposing sidewalls of the blade 88.

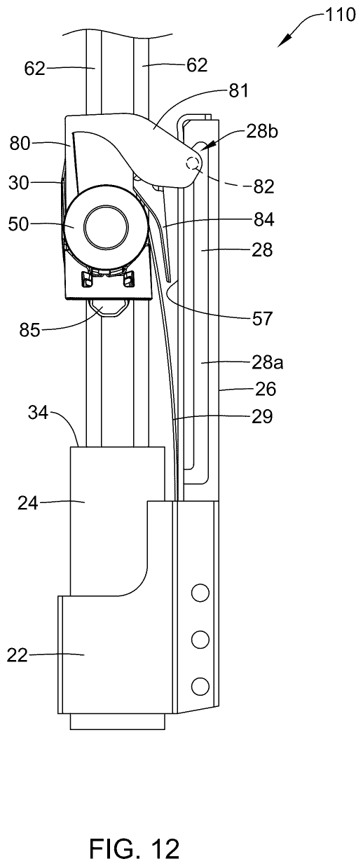

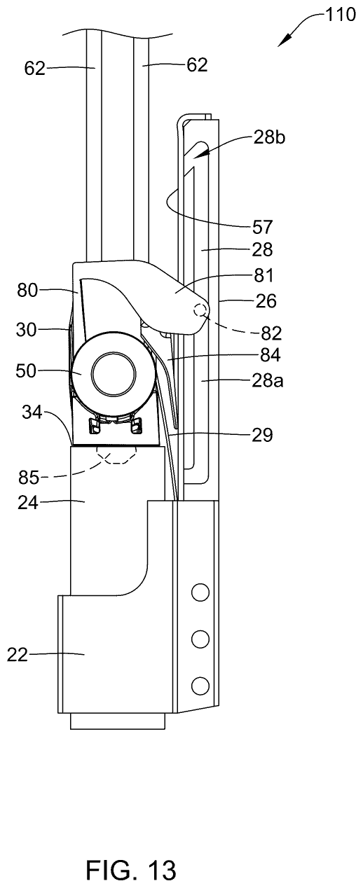

FIGS. 12 and 13 illustrate the wear state monitor assembly, including the wear state monitor 50 and the spacer 30, coupled to the brush holder assembly 110 in a disengaged position and an engaged position, respectively. In the disengaged position shown in FIG. 12, the wear state monitor 50 and the spacer 30 may be positioned above and spaced away from the upper surface 34 of the carbon brush 24. In the disengaged position shown in FIG. 12, the spacer 30 may be coupled to the mounting beam 26 of the brush holder assembly 110 with the spacer spaced away from and disengaged from the brush 24. In the disengaged position, the pins 82 of the spacer 30 may be engaged in the 28b of the longitudinal slots 28 extending along opposing sides of the mounting beam 26. For example, a first pin 82 extending from the first arm 81 of the spacer may be engaged in the lateral portion 28b of a first elongate channel 28 on a first lateral side of the mounting beam 26 and a second pin 82 extending from the second arm 81 of the spacer 30 may be engaged in the lateral portion 28b of a second elongate channel 28 on a second lateral side of the mounting beam 26. The pins 82 may rest in the lateral portions 28b of the elongate channels 28 against a surface of the back plate 57 to lock or retain the spacer 30 in the disengaged position spaced away from the upper surface 34 of the brush 24 with the keel 85 spaced away from and disengaged from the longitudinal channel 39 of the brush 24. The downward force applied to the wear state monitor 50 and the spacer 30 from the spring 29, the coiled portion 31 of which surrounds the wear state monitor 50, is sufficient to retain the pins 82 in the lateral portions 28b of the elongate channels 28 against the back plate 57. In the disengaged position, the tongue 84 (e.g., the rear surface 83 of the tongue 84) may also be spaced away from the back plate 57

Tilting the spacer 30 toward the back plate 57 extending along the mounting beam 26 may move the first and second pins 82 out of the lateral portions 28b and into the elongate portions 28a of the elongate channels 28, permitting the first and second pins 82 to travel longitudinally along the elongate portions 28a of the elongate channels 28, thereby permitting the spacer 30, and the associated wear state monitor 50, to move longitudinally toward the upper surface 34 of the brush 24 and into the engaged position, shown in FIG. 13. In the engaged position, the spacer 30 may be moved longitudinally downward into engagement with the upper surface 34 of the brush 24 and the keel 85 may be positioned in the longitudinal channel 39. Thus, the keel 85 may be insertable into the longitudinal channel 39 in a direction generally perpendicular to the upper surface 34 of the brush 24 such that the keel 85 initially enters the longitudinal channel 39 from the upper surface 34 of the brush 24. As shown in FIG. 13, the keel 85 may extend less than the entire length of the longitudinal channel 39, measured from the front surface 21 of the brush 24 to the rear surface 23 of the brush 24. For example, the keel 85 may be positioned within the longitudinal channel 39 such that the extents of the keel 85 are spaced inward of and away from the front surface 21 and/or the rear surface 23 of the brush 24. The lower surface of the spacer 30 may be juxtaposed with and in contact with the upper surface 34 of the brush 24, without fixedly attaching the spacer 30 to the brush 24. Therefore, the spacer 30 may be readily removable from the brush 24 to replace the brush 24 while reusing the spacer 30 and wear state monitor 50. Moreover, the keel 85 may be designed to be inserted into or removed from the longitudinal channel 39 through manual manipulation of the spacer 30 relative to the brush 24 without damaging either the spacer 30 or the brush 24, and/or without breaking an adhesive bond or other interface therebetween.

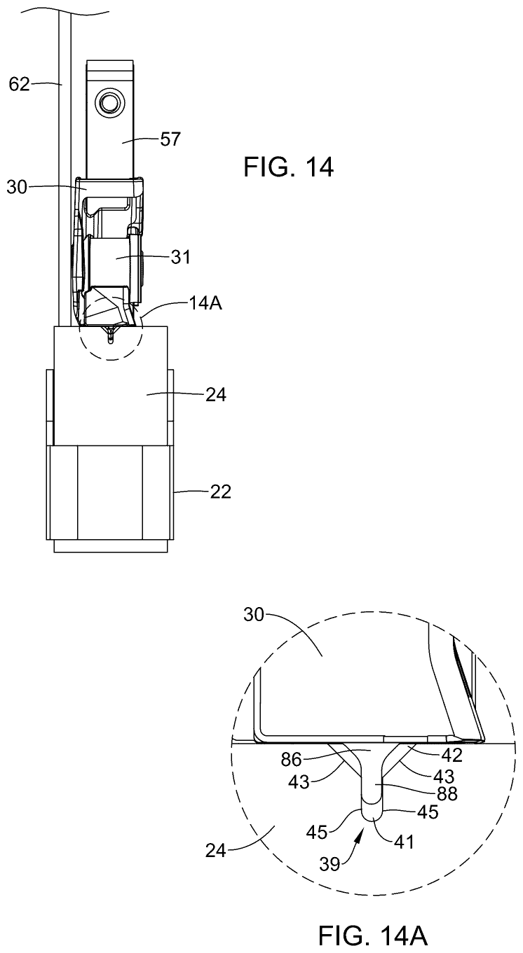

In some instances, the keel 85 may frictionally engage the sidewall of the longitudinal channel 39 when inserted therein, but be readily removed therefrom with a manual extraction force applied to the spacer 30 without damaging either the spacer 30 or the brush 24. As shown in FIG. 14, and the enlarged view of FIG. 14A, the blade 88 of the keel 85 may be insertable into the lower region 41 of the longitudinal channel 39 while the base region 86 of the keel 85 may be positioned in the upper region 42 of the longitudinal channel 39. Thus, with the body 80 of the spacer 30 positioned flat against the upper surface 34 of the brush 24, the keel 85 may extend into the longitudinal channel 39. The blade 88 may extend into the lower region 41, but not extend all the way to the base of the lower region 41 of the longitudinal channel 39. The side surfaces of the blade 88 may be juxtaposed with and/or in contact with the side surfaces 45 of the lower region 41. In some instances, the side surfaces of the blade 88 may be frictionally engaged with the side surfaces 45 of the lower region 41. The base region 86 of the keel 85 may have a width greater than the width W1 (see FIG. 4) of the lower region 41, such that the base region 86 cannot extend into the lower region 41. The upper region 42 may be shaped to accommodate the base region 86 of the blade 85 therein. The width W2 (see FIG. 4) of the upper region 42 may be greater than the maximum width of the base region 86 of the keel 85. In some instances, the tapered surfaces of the base region 86 of the keel 85 may face, but be spaced away from the tapered surfaces 43 of the upper region 42 of the longitudinal channel 39, defining a gap between the tapered surfaces of the base region 86 of the keel 85 and the tapered surfaces 43 of the upper region 42 of the longitudinal channel 39. In other embodiments, the tapered surfaces of the base region 86 of the keel 85 may face and be in contact with the tapered surfaces 43 of the upper region 42 of the longitudinal channel 39. In some instances, the tapered surfaces of the base region 86 of the keel 85 may be generally parallel to the corresponding tapered surfaces of the upper region 42 of the longitudinal channel 39.

As discussed above, the sensor of the brush monitoring system 100 may produce a signal corresponding to the rotation (e.g., the absolute angular position) of the wear state monitor 50 relative to the magnet described above. For example, the sensor 56 may be able to sense a change in the magnetic field created by the magnet, thus determining a rotational orientation of the wear state monitor 50. The signals provided by the sensor corresponding to the rotational orientation of the wear state monitor 50 may be compared to determine an angular displacement of the wear state monitor 50 between two temporal occasions, such as between an angular position of the wear state monitor 50 when the brush 24 is installed in the brush holder assembly 110 and some later time when the brush 24 has worn. These signals (corresponding to the angular displacement and/or rotational orientation of the wear state monitor 50) may be communicated to a site monitor via a variety of communication methods. In some instances, the sensor may additionally include an accelerometer configured to sense dynamic vibration of the brush 24 in the brush holder 22. For example, the sensor, in addition to sensing angular displacement and/or rotational orientation of the wear state monitor 50, may sense transient angular displacement of the wear state monitor 50 corresponding to dynamic vibration of the brush 24.

For example, in some instances, the sensor may obtain values corresponding to a first position of the brush 24, at a first temporal occasion T₀, such as an initial position of the brush 24 when the brush 24 has been placed on the electrical device and having approximately no wear. In other words, the sensor may be used to sense the angular position of the wear state monitor 50 at the initial temporal occasion T₀. The sensor may obtain values corresponding to a position of the brush 24 at a later temporal occasion T₁ after the brush has been worn a first amount. In other words, the sensor may be used to sense the angular position of the wear state monitor 50 at the temporal occasion T₁. The sensor may obtain additional values corresponding to a further positions of the brush 24 at later temporal occasions T₂, T₃, T₄, etc. after the brush has been worn an additional amount. In other words, the sensor may be used to sense the angular position of the wear state monitor 50 at the further temporal occasions T₂, T₃, T₄, etc. The angular displacement of the wear state monitor 50 between each temporal occasion may be used to determine the diminution in length of the brush 24, and thus the current wear state of the brush 24 and/or project when the brush 24 will diminish in length to a threshold amount at a future time. In some instances, the threshold amount may correspond to a brush length approximating when the brush 24 has a predetermined amount of wear (e.g., approaching the replacement threshold, maximum allowable wear, etc.). Information relating to the rotation or angular displacement of the wear state monitor 50 may be analyzed to determine an amount of diminution in length of the brush 24, a current wear state of the brush 24, a wear rate of the brush 24, and/or predict a future wear state of the brush 24 at a future time. Such information and/or data regarding the state of the brush 24 may be communicated to a site monitoring device and/or a remote monitoring device, located at the same and/or at a different geographical location from the geographical location of the electrical machine in which the brush monitoring system 100 is in service.

Those skilled in the art will recognize that aspects of the present disclosure may be manifested in a variety of forms other than the specific embodiments described and contemplated herein. Accordingly, departure in form and detail may be made without departing from the scope and spirit of the present disclosure as described in the appended claims.

What is claimed is:

1. A carbon brush assembly for an electrical device, comprising:
a carbon brush including an upper surface, a lower surface opposite the upper surface, a front surface extending from the upper surface to the lower surface, and a rear surface opposite the front surface, the rear surface extending from the upper surface to the lower surface;
one or more lead wires extending out of the carbon brush at an insertion point on the upper surface;
a longitudinal channel extending into the carbon brush from the upper surface at a location spaced away from the insertion point of the one or more lead wires and unobstructed by the one or more lead wires,
wherein the longitudinal channel includes a lower region having a first width and an upper region having a second width at the upper surface;
wherein the second width is greater than the first width.

2. The carbon brush assembly of claim 1, wherein the lower region of the longitudinal channel is defined between first and second opposing sidewalls.

3. The carbon brush assembly of claim 2, wherein the first and second opposing sidewalls are parallel.

4. The carbon brush assembly of claim 2, wherein the lower region further includes a concave base wall extending from the first sidewall to the second sidewall.

5. The carbon brush assembly of claim 1, wherein the upper region is defined by tapering sidewalls tapering outwardly from the lower region toward the upper surface.

6. The carbon brush assembly of claim 1, wherein the longitudinal channel extends from the front surface to the rear surface.

7. The carbon brush assembly of claim 1, wherein an upper extent of the longitudinal channel at the upper surface of the brush is the widest portion of the longitudinal channel.

8. A system for monitoring the wear state of a carbon brush, comprising:
a carbon brush including an upper surface and a lower surface opposite the upper surface, a front surface extending from the upper surface to the lower surface, and a rear surface opposite the front surface, the rear surface extending from the upper surface to the lower surface, the carbon brush including a longitudinal channel extending into the carbon brush from the upper surface, the longitudinal channel extending from the front surface to the rear surface;
a spacer including a body and a keel extending from a lower surface of the body, the lower surface of the body juxtaposed with the upper surface of the carbon brush such that the keel extends into the longitudinal channel of the carbon brush from the upper surface; and
a wear state monitor positioned within a cavity of the body of the spacer;
wherein the keel includes a base portion extending downward from the body and a blade extending downward from the base portion, the blade including first and second parallel sidewalls.

9. The system of claim 8, wherein the longitudinal channel includes a lower region having a first width and an upper region having a second width at the upper surface of the carbon brush, wherein the second width is greater than the first width.

10. The system of claim 9, wherein the base region of the keel is positioned in the upper region of the longitudinal channel and the blade of the keel is positioned in the lower region of the longitudinal channel.

11. The system of claim 10, wherein the lower region of the longitudinal channel includes first and second opposing sidewalls.

12. The system of claim 11, wherein the first and second opposing sidewalls of the lower region of the longitudinal channel are parallel.

13. The system of claim 11, wherein the first and second parallel sidewalls of the blade frictionally engage the first and second opposing sidewalls of the lower region of the longitudinal channel.

14. The system of claim 8, wherein the base portion of the keel includes first and second tapered walls.

15. The system of claim 14, wherein the longitudinal channel includes an upper region having first and second tapering sidewalls and a lower region having first and second parallel sidewalls.

16. The system of claim 15, wherein the first and second tapered walls of the keel are facing the first and second tapering sidewalls of the upper region of the longitudinal channel.

17. The system of claim 16, wherein the first and second tapered walls of the keel are spaced away from the first and second tapering sidewalls of the upper region of the longitudinal channel when the keel is positioned in the lower region of the longitudinal channel.

18. The system of claim 16, wherein the blade is frictionally engaged with the first and second parallel sidewalls of the lower region of the longitudinal channel.

19. A brush wear monitoring assembly comprising:
a spacer including:
a body;
a keel extending from a lower surface of the body;
first and second arms extending from the body and spaced apart from one another;
a first pin extending from an inner surface of the first arm toward the second arm; and
a second pin extending from an inner surface of the second arm toward the first arm;
wherein the first pin is coaxial with the second pin; and
a wear state monitor positioned within a cavity of the body of the spacer.

20. The brush wear monitoring assembly of claim 19, wherein the keel includes a base portion having tapering sidewalls extending downward from the body and a blade extending downward from the base portion, the blade including first and second parallel sidewalls.
